(19) United States
(12) Patent Application Publication
(10) Pub. No.: US 2016/0123276 A1
(43) Pub. Date: May 5, 2016

(54) LIQUEFIED GAS FUEL SUPPLYING APPARATUS

(71) Applicant: TOYOTA JIDOSHA KABUSHIKI KAISHA, Toyota-shi (JP)

(72) Inventors: Mutsumi TSUJINO, Nagoya-shi (JP); Akito UCHIDA, Toyota-shi (JP)

(21) Appl. No.: 14/930,019

(22) Filed: Nov. 2, 2015

(30) Foreign Application Priority Data
Nov. 4, 2014 (JP) 2014-224315

(51) Int. Cl. F02M 21/02

(52) U.S. Cl. CPC F02M 21/0245; F02M 21/0221

(57) ABSTRACT

A liquefied gas fuel supplying apparatus includes an injector that injects fuel to an engine, a fuel tank that stores the fuel, a fuel pump that pumps the fuel from the fuel tank to the injector, a fuel cooler that cools the fuel that is pumped from the fuel pump to the injector, a fuel temperature sensor that detects a fuel temperature in a pipe, and an ECU. The ECU, during engine operation, estimates the fuel temperature in the pipe after engine stop, based on a detection value detected by the fuel temperature sensor, and performs drive control of the fuel cooler to cool the fuel, when the estimated temperature is higher than a temperature that is evaluated from a predetermined saturated vapor pressure curve.

### INCORPORATION BY REFERENCE

The disclosure of Japanese Patent Application No. 2014-224315 filed on Nov. 4, 2014 including the specification, drawings and abstract is incorporated herein by reference in its entirety.

### BACKGROUND OF THE INVENTION

1. Field of the Invention

The invention relates to a liquefied gas fuel supplying apparatus configured to supply liquefied gas to an engine, as fuel.

2. Description of Related Art

Conventionally, in this kind of technology, liquefied gas fuel has a low boiling point compared to diesel oil, gasoline and the like, and has an easy-to-vaporize property. Therefore, the liquefied gas fuel sometimes vaporizes due to a temperature rise in the pumping to an injector by a fuel pump, or the like, and the fuel injection property of the injector is likely to become unstable. Hence, for dealing with such a problem, for example, the following liquefied gas fuel supplying apparatus described in Japanese Patent Application Publication No. 2010-174692 has been proposed. The apparatus includes a fuel tank filled with dimethyl ether (DME) as the liquefied gas fuel, a high-pressure pump that pressurizes the liquefied gas fuel fed from the fuel tank and supplies the liquefied gas fuel to an injector, a supply pump that supplies the liquefied gas fuel from the fuel tank to the high-pressure pump, and a fuel cooler that cools the liquefied gas fuel to be fed from the supply pump to the high-pressure pump. Then, when the liquefied gas fuel is fed to the injector, the fuel cooler works all the time, and the liquefied gas fuel is fed from the supply pump to the high-pressure pump while being constantly cooled. As a result, the liquefied gas fuel with a low temperature can be stably fed to the high-pressure pump, resulting in the stabilization of the injection property of the liquefied gad fuel.

### SUMMARY OF THE INVENTION

Meanwhile, in a multiple cylinder engine, multiple injectors are provided in parallel, on a delivery pipe. Then, in a period during which the atmospheric temperature is relatively high, when the engine is stopped after a high-load operation and then is restarted, there is a concern that the liquefied gas fuel in the delivery pipe vaporizes due to the remaining heat generated from an engine body and the fuel injection property of the injectors becomes unstable. Hence, when the liquefied gas fuel in delivery pipe has vaporized, a “pump pre-drive control” for securing restartability is sometimes performed at the restart time of the engine. That is, the temperature and pressure of the liquefied gas fuel in the delivery pipe are detected, and when it is determined that the liquefied gas fuel has vaporized based on the detection result, the fuel pump is driven in advance of a starter operation of the engine (for example, for 2 to 7 seconds). Thereby, the liquefied gas fuel in the delivery pipe is cooled in a circulation manner while being pressurized. Such a pump pre-drive control can be employed not only in an ordinary engine vehicle using the liquefied gas fuel but also in a hybrid electric vehicle using the liquefied gas fuel.

In addition, in an ordinary engine vehicle or hybrid vehicle using the liquefied gas fuel and employing a start-stop system, the engine is intermittently stopped. Such a vehicle cannot afford to execute the pump pre-drive control, at the time of a moving request or a starting request to the engine.

However, in the apparatus described in JP 2010-174692 A, when the liquefied gas fuel is fed to the injector, the fuel cooler works all the time. Therefore, the fuel efficiency is likely to decrease because of that. Further, when the engine is stopped after a high-load operation and then is restarted, it is not possible to deal with the vaporization of the liquefied gas fuel, and the restartability at a high temperature is likely to worsen.

Further, when the pump pre-drive control is performed in an ordinary vehicle or a hybrid vehicle, it is necessary to secure the time to drive the fuel pump at the start time of the engine. Therefore, the driver needs to wait for the start, resulting in the impairment of start responsivity. Furthermore, it is possible to detect that the condition in the delivery pipe shifts to a vaporization region, during the intermittent stop, and drive the fuel pump. However, when the fuel pump is driven and stopped during the engine stop without the operation by a driver, and the driving sound, as noise, is likely to give the driver uncomfortable feeling.

The invention provides a liquefied gas fuel supplying apparatus that enhances the restartability of the engine at a high temperature, while suppressing the decrease in the fuel efficiency due to the working of the fuel cooler, and that does not give the driver the uncomfortable feeling due to the pump noise, without impairing the start responsivity of the engine.

A first aspect of the invention provides a liquefied gas fuel supplying apparatus including:
an injector configured to perform injection supply of liquefied gas fuel to an engine;
a fuel tank configured to store the liquefied gas fuel;
a fuel pump configured to pump the liquefied gas fuel stored in the fuel tank, to the injector through a pipe;
a fuel cooler configured to cool the liquefied gas fuel that is pumped from the fuel pump to the injector through the pipe;
a fuel temperature detector configured to detect a temperature of the liquefied gas fuel in the pipe positioned on a downstream side relative to the fuel cooler; and
an electronic control unit configured to:
(i) determine whether the liquefied gas fuel in the pipe positioned on the downstream side relative to the fuel cooler vaporizes after the engine is stopped, based on a detection value detected by the fuel temperature detector, the detection value being a detection value while the engine is operated; and
(ii) perform drive control of the fuel cooler to cool the liquefied gas fuel, when the electronic control unit determines that the liquefied gas fuel vaporizes.

According to the above configuration, only when it is determined that the liquefied gas fuel in the pipe vaporizes after the engine stop based on the detection value during the engine operation by the fuel temperature detector, the fuel cooler is driven. Therefore, it is unnecessary to drive the fuel cooler all the time. Further, the liquefied gas fuel is appropriately cooled during the engine operation, and therefore, at the restart time of the engine at a high temperature, the temperature of the liquefied gas fuel is kept low, resulting in the suppression of the vaporization of the fuel. Since the cooling of the liquefied gas fuel is performed during the engine operation, it is unnecessary to deal with the vaporization of the liquefied gas fuel at the start time of the engine. Further, during the engine stop, devices such as the fuel pump are not driven or stopped without the operation by the driver.

According to the above configuration, it is possible to enhance the restartability of the engine at a high-temperature, while suppressing the decrease in the fuel efficiency due to the working of the fuel cooler, and it is possible to avoid giving the driver the uncomfortable feeling due to the pump noise, without impairing the start responsivity of the engine.

A second aspect of the invention provides a liquefied gas fuel supplying apparatus including:
an injector configured to perform injection supply of liquefied gas fuel to an engine;
a fuel tank configured to store the liquefied gas fuel;
a fuel pump configured to pump the liquefied gas fuel stored in the fuel tank, to the injector through a pipe;
a fuel cooler configured to cool the liquefied gas fuel that is pumped from the fuel pump to the injector through the pipe;
a fuel temperature detector configured to detect a temperature of the liquefied gas fuel in the pipe positioned on a downstream side relative to the fuel cooler; and
an electronic control unit configured to:
(i) estimate the temperature of the liquefied gas fuel in the pipe positioned on the downstream side relative to the fuel cooler, based on a detection value detected by the fuel temperature detector, while the engine is operated, the temperature being a temperature after the engine is stopped; and
(ii) perform drive control of the fuel cooler to cool the liquefied gas fuel, when the estimated temperature is higher than a temperature that is evaluated from a predetermined saturated vapor pressure curve.

According to the above configuration, only when it is determined that the temperature estimated as the temperature of the liquefied gas fuel after the engine stop is higher than the temperature that is evaluated from the predetermined saturated vapor curve, the fuel cooler is driven. Therefore, it is unnecessary to drive the fuel cooler all the time. Further, the liquefied gas fuel is appropriately cooled during the engine operation, and therefore, at the restart time of the engine at a high temperature, the temperature of the liquefied gas fuel is kept low, resulting in the suppression of the vaporization of the fuel. Since the cooling of the liquefied gas fuel is performed during the engine operation, it is unnecessary to deal with the vaporization of the liquefied gas fuel at the start time of the engine. Further, during the engine stop, devices such as the fuel pump are not driven or stopped without the operation by the driver.

According to the above configuration, it is possible to enhance the restartability of the engine at a high-temperature, while suppressing the decrease in the fuel efficiency due to the working of the fuel cooler, and it is possible to avoid giving the driver the uncomfortable feeling due to the pump noise, without impairing the start responsivity of the engine.

In the liquefied gas fuel supplying apparatus according to the above aspect, the electronic control unit may be configured to estimate the temperature of the liquefied gas fuel in the pipe positioned on the downstream side relative to the fuel cooler, by adding a predetermined value to the detection value detected by the fuel temperature detector, the temperature being the temperature after the engine is stopped, the predetermined value being previously evaluated by an experiment.

According to the above configuration, the predetermined value previously evaluated by the experiment is simply added to the detection value by the fuel temperature detector. Therefore, it is possible to easily estimate the temperature of the liquefied gas fuel after the engine stop.

According to the above configuration, it is possible to simplify a preferred control of the fuel cooler.

In the liquefied gas fuel supplying apparatus according to the above aspect, the liquefied gas fuel supplying apparatus may include a pressure regulator configured to regulate a pressure of the liquefied gas fuel that is pumped to the injector. The electronic control unit may be configured to: (i) perform drive control of the pressure regulator so as to reduce the pressure of the liquefied gas fuel that is pumped to the injector, depending on a temperature difference between the estimated temperature and the temperature that is evaluated from the saturated vapor pressure curve, when the estimated temperature is lower than the temperature that is evaluated from the saturated vapor pressure curve; and (ii) decrease pumping force to the liquefied gas fuel by the fuel pump, by a reduction quantity of the pressure of the liquefied gas fuel.

According to the above configuration, the quantity of the pressurization to liquefied gas fuel by the fuel pump is reduced, and therefore, the load on the fuel pump is reduced.

According to the above configuration, it is possible to extend the durability life of the fuel pump, and it is possible to reduce the electric power consumption by the fuel pump, and further enhance the fuel efficiency of the engine, corresponding to the quantity.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic configuration diagram showing a liquefied gas fuel supplying apparatus according to a first embodiment;

FIG. 2 is a flowchart showing the content of a fuel supplying control according to the first embodiment;

FIG. 3 is a table showing temperature data that is referenced for evaluating a temperature rising quantity according to the first embodiment;

FIG. 4 is a graph showing saturated vapor pressure property data that is referenced for estimating a saturated vapor pressure curve according to the first embodiment;

FIG. 5 is a graph showing a relation of a saturated vapor pressure curve, temperature and pressure according to the first embodiment;

FIG. 6 is a graph showing an effect of the fuel supplying control according the first embodiment;

FIG. 7 is a schematic configuration diagram showing a liquefied gas fuel supplying apparatus according to a second embodiment;

FIG. 8 is a flowchart showing the content of a fuel supplying control according to the second embodiment;

FIG. 9 is a graph showing an effect of the fuel supplying control according to the second embodiment; and

FIG. 10 is a schematic configuration diagram showing a liquefied gas fuel supplying apparatus according to a third embodiment.

### DETAILED DESCRIPTION OF EMBODIMENTS

Hereinafter, a first embodiment in which the liquefied gas fuel supplying apparatus in the invention is embodied will be described in detail, with reference to the drawings. In the embodiment, a liquefied gas fuel supplying apparatus that is embodied in an LPG engine system using liquefied petroleum gas (LPG) fuel as liquefied gas fuel will be described.

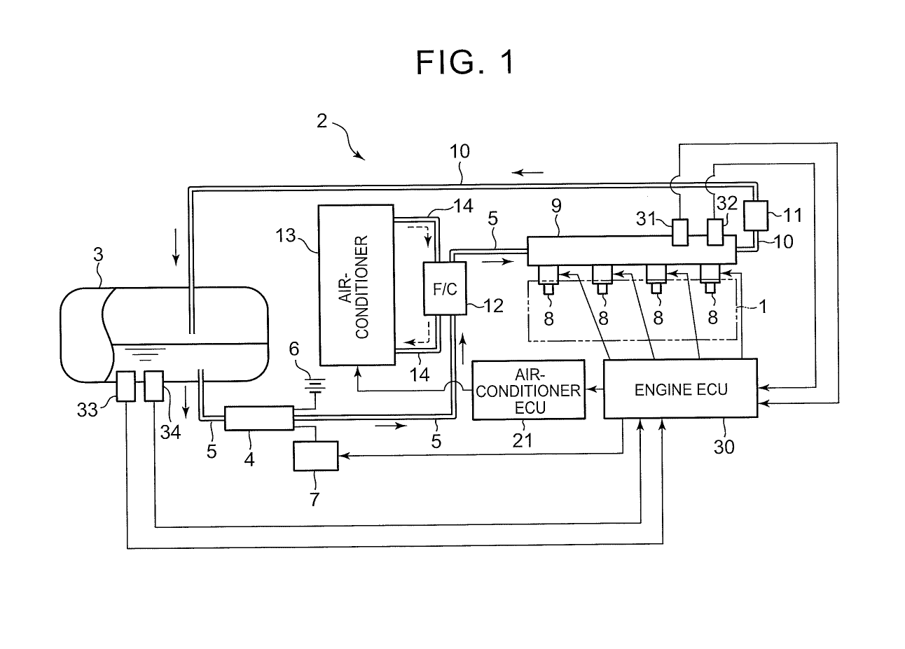

FIG. 1 shows, as a schematic configuration diagram, the liquefied gas fuel supplying apparatus in the first embodiment. The LPG engine system, which is mounted in a vehicle, includes an engine 1, and a liquefied gas fuel supplying apparatus 2 that supplies the LPG fuel to the engine 1. The liquefied gas fuel supplying apparatus 2 includes a fuel tank 3 for storing the LPG fuel in a liquid state. A fuel pump 4 externally connected with the fuel tank 3 is configured to suck in the LPG fuel stored in the tank 3 and discharge the LPG fuel to a fuel passage 5. The fuel passage 5 extends toward the engine 1. In the first embodiment, the fuel pump 4 is configured to suck in the fuel and discharge the fuel to the fuel passage 5, by rotating an impeller with a motor. With the fuel pump 4, a battery 6 is connected for supplying an electric power source. The fuel pump 4 is configured to be driven by a pump controller 7.

In the first embodiment, the engine 1 is a reciprocating-type engine with four cylinders, and four injectors 8 for performing the injection supply of the LPG fuel to the engine 1 are provided so as to correspond to the respective cylinders. The injectors 8 are provided in parallel, on a delivery pipe 9. Each injector 8, which includes a solenoid valve, is configured to be electrically driven for opening and closing. Therefore, the LPG fuel stored in the fuel tank 3 is discharged from the fuel pump 4, and thereby, is pumped to the injectors 8 through the fuel passage 5 and the delivery pipe 9. By the working of the injectors 8, the LPG fuel pumped to the injectors 8 is injected and supplied to the cylinders. The LPG fuel injected from the injectors 8 composes, in the cylinders, a combustible gas mixture, together with the air taken in from an intake passage (the illustration is omitted), and is used for combustion. The excess LPG fuel in the delivery pipe 9 is returned to the fuel tank 3 through a return passage 10, as return fuel. On the return passage 10, a pressure-operated pressure regulator 11 for regulating the fuel pressure in the delivery pipe 9 to a certain predetermined value is provided.

Here, in the delivery pipe 9, a first fuel temperature sensor 31 for detecting a fuel temperature (first fuel temperature) TDF in the delivery pipe 9 is provided. Similarly, in the delivery pipe 9, a first fuel pressure sensor 32 for detecting a fuel pressure (first fuel pressure) PDF in the delivery pipe 9 is provided. In the embodiment, the fuel passage 5 and the delivery pipe 9, which are positioned on the downstream side relative to a fuel cooler 12 described later, are examples of the downstream side pipe in the invention, and the first fuel temperature sensor 31 is an example of the fuel temperature detector in the invention.

Meanwhile, in the fuel tank 3, a second fuel temperature sensor 33 for detecting a fuel temperature (second fuel temperature) TTF in the fuel tank 3 is provided. Similarly, in the fuel tank 3, a second fuel pressure sensor 34 for detecting a fuel pressure (second fuel pressure) PTF in the fuel tank 3 is provided.

Furthermore, on the way of the fuel passage 5, the fuel cooler (F/C) 12 for cooling the LPG fuel that is pumped from the fuel pump 4 to the injectors 8 through the fuel passage 5 and the delivery pipe 9 is provided. The fuel cooler 12 is configured such that the coolant to flow through an air-conditioner 13 provided in the vehicle flows through a coolant passage 14. Thereby, heat exchange is performed between the LPG fuel in a liquid phase state to flow through the fuel passage 5 and the coolant, so that the LPG fuel is cooled. Here, the air-conditioner 13, as is well known, is constituted by a compressor, a condenser, a vaporizer, pipes connecting them, and the like, and is configured such that the coolant to flow through the pipes can be cooled. Therefore, when the air-conditioner 13 is turned on and the coolant is cooled in the interior, the coolant flows into the fuel cooler 12 through the coolant passage 14. Thereby, the LPG fuel to flow through the fuel passage 5 is cooled. On the other hand, when the air-conditioner 13 is turned off, the coolant does not flow into the fuel cooler 12. Thereby, the LPG fuel to flow through the fuel passage 5 is not cooled. The air-conditioner 13 is configured to be driven and controlled by an air-conditioner electronic control unit (air-conditioner ECU) 21.

In the embodiment, an engine ECU 30 is provided for controlling the injectors 8, the fuel pump 4 and the air-conditioner 13. The engine ECU 30 is an example of the electronic control unit in the invention. The injectors 8, the pump controller 7, the air-conditioner ECU 21, the fuel temperature sensors 31, 33, and the fuel pressure sensors 32, 34 are connected with the engine ECU 30. The engine ECU 30 controls the injectors 8, the pump controller 7 and the air-conditioner ECU 21, based on detection values by the fuel temperature sensors 31, 33 and the fuel pressure sensors 32, 34.

The engine ECU 30 includes a central processing unit (CPU), various memories, an external input circuit, an external output circuit and the like. The engine ECU 30 is configured to execute a fuel supplying control in accordance with a predetermined control program, based on the detection values input from the respective sensors 31 to 34 through the input circuit.

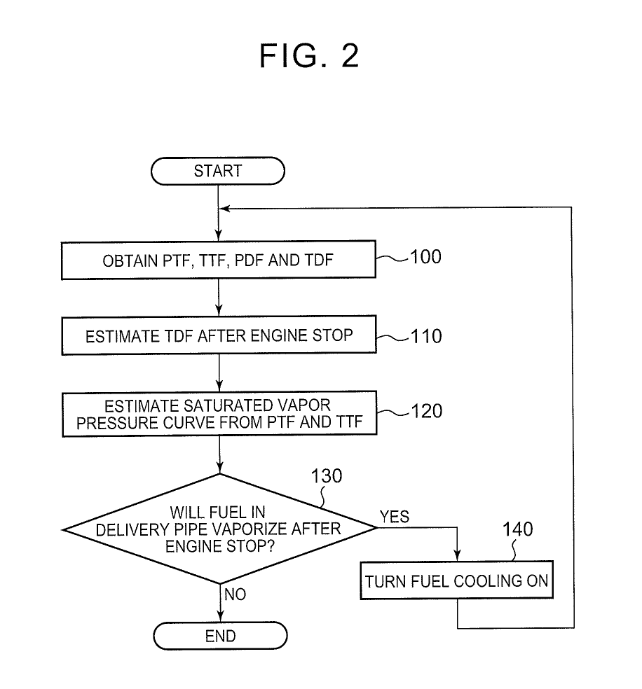

Next, the content of the fuel supplying control to be executed by the engine ECU 30 will be described with reference to a flowchart of FIG. 2.

When the process transitions to this routine, the engine ECU 30, in step 100, obtains each of the values of the second fuel pressure PTF, the second fuel temperature TTF, the first fuel pressure PDF and the first fuel temperature TDF that are detected by the sensors 31 to 34.

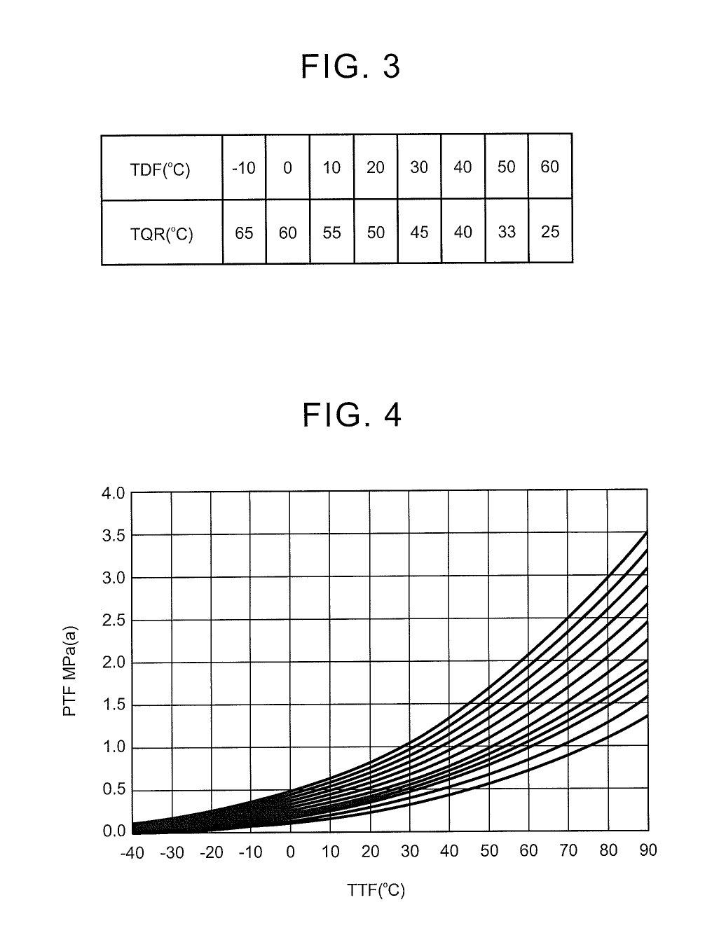

Next, in step 110, the engine ECU 30 estimates the first fuel temperature TDF after the engine stop. That is, the engine ECU 30 adds a temperature rising quantity TQR after the engine stop (for example, after 60 minutes), to the current first fuel temperature TDF, and thereby, estimates the first fuel temperature TDF after the engine stop. Here, the temperature rising quantity TQR can be evaluated, for example, by reference to the temperature data shown as a table in FIG. 3. The temperature rising quantities TQR in the temperature data are predetermined values previously evaluated by an experiment. In the temperature data, as the first fuel temperature TDF rises from “−10° C.” to “60° C.”, the temperature rising quantity TQR decreases from “65° C.” to “25° C.”. Accordingly, for example, when the current first fuel temperature TDF is “40° C.”, the temperature rising quantity TQR after the engine stop is “40° C.”, and therefore, the first fuel temperature TDF after the engine stop can be estimated to be “40+40=80 (° C.)”.

Next, in step 120, the engine ECU 30 estimates a saturated vapor pressure curve from the second fuel pressure PTF and the second fuel temperature TTF. The saturated vapor pressure curve can be estimated, for example, by reference to the saturated vapor pressure property data shown as a graph in FIG. 4. In FIG. 4, the abscissa indicates the second fuel temperature TTF, and the ordinate indicates the second fuel pressure PTF. The multiple curves shown in FIG. 4 are saturated vapor pressure curves, and the difference in the curves means the difference in the ratio of LPG in the fuel. Here, the highest curve indicates a case of 100% propane, and the curves lower than this indicate, in order, cases in which the content percentage of propane decreases and the content percentage of butane increases.

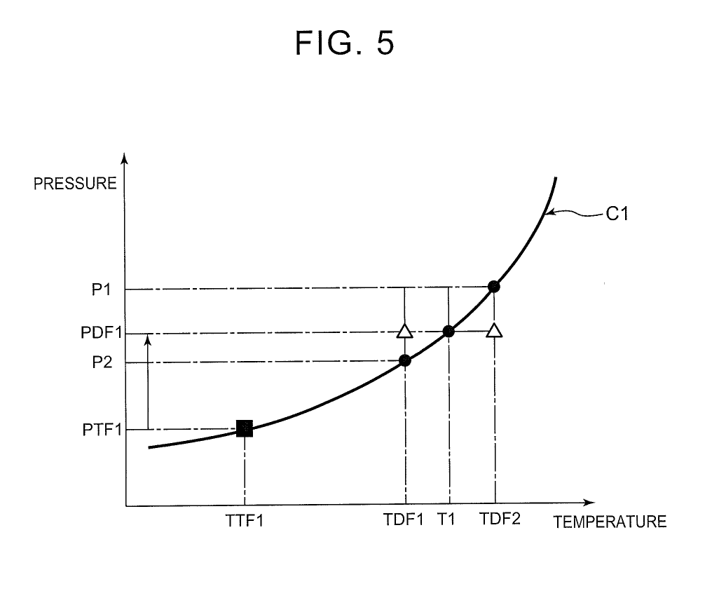

Next, in step 130, the engine ECU 30 determines whether the LPG fuel will vaporize in the delivery pipe 9 after the engine stop (for example, after 60 minutes). That is, the engine ECU 30 determines whether the first fuel temperature TDF estimated in step 110 is higher than a temperature that is evaluated from the saturated vapor pressure curve estimated in step 120 when the first fuel pressure PDF is the predetermined value regulated by the pressure regulator 11. This will be described with reference to FIG. 5. FIG. 5 is a graph showing a relation of a saturated vapor pressure curve C1, the temperature and the pressure. The saturated vapor pressure curve C1 is estimated from the relation between a certain second fuel temperature TTF1 and a certain second fuel pressure PTF1. The LPG fuel is pressurized by the fuel pump 4, and thereby, rises from the certain second fuel pressure PTF1 to a certain first fuel pressure PDF1. The first fuel pressure PDF1 corresponds to the predetermined value regulated by the pressure regulator 11. From the saturated vapor pressure curve C1, a temperature T1 is evaluated corresponding to the certain first fuel pressure PDF1. In the case where the first fuel temperature TDF after the engine stop is higher than the temperature T1 (in the case of TDF2), the certain first fuel pressure PDF1 is lower than a pressure P1 that is evaluated from the saturated vapor pressure curve C1. Therefore, the LPG fuel in the delivery pipe 9 vaporizes. On the other hand, in the case where the first fuel temperature TDF after the engine stop is lower than the temperature T1 that is evaluated from the saturated vapor pressure curve C1 (in the case of TDF1), the certain first fuel pressure PDF1 is higher than a pressure P2 that is evaluated from the saturated vapor pressure curve C1. Therefore, the LPG fuel in the delivery pipe 9 does not vaporize. In the case where the determination result in step 130 is positive, it can be determined that the LPG fuel will vaporize in the delivery pipe 9, and the engine ECU 30 makes the transition of the process to step 140. In the case where the determination result in step 130 is negative, the engine ECU 30 once terminates the subsequent process.

Then, in step 140, the engine ECU 30 turns the fuel cooling on, and thereafter, returns the process to step 100. Here, the engine ECU 30 commands the air-conditioner ECU 21 to turn the air-conditioner 13 on, and in response to this, the air-conditioner ECU 21 turns the air-conditioner 13 on. Thereby, the coolant flows through the fuel cooler (F/C) 12, and the LPG fuel to be pumped from the fuel pump 4 to the delivery pipe 9 is cooled.

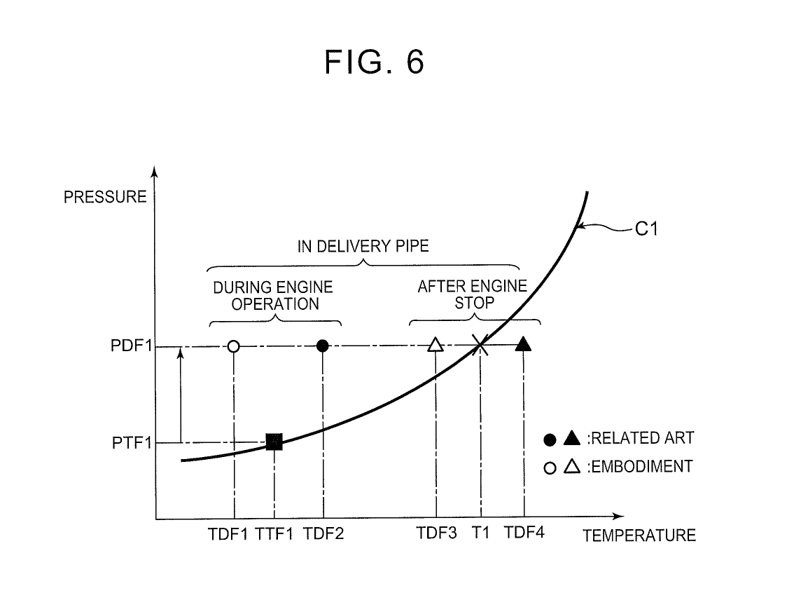

FIG. 6 shows, as a graph, an effect of the above fuel supplying control. In FIG. 6, the white circle, the white triangle, the black circle and the black triangle each indicate the data in the delivery pipe 9. The white circle and the black circle each indicate the data during the engine operation, and the white triangle and the black triangle indicate the data after the engine stop. Further, the white circle and the white triangle indicate the data in the embodiment, and the black circle and the black triangle indicate the data in the related art. As is obvious from FIG. 6, in the embodiment, the rise in the first fuel temperature TDF after the engine stop is estimated during the engine operation, and the LPG fuel is moderately cooled. Therefore, at the certain first fuel pressure PDF1 after the pressurization by the fuel pump 4, a certain first fuel temperature TDF1 (white circle) is lower than a certain first fuel temperature TDF2 (black circle) in the related art. As a result, after the engine stop, a certain first fuel temperature TDF3 (white triangle) is lower than the temperature T1 (cross mark) evaluated from the saturated vapor pressure curve C1. This is different from the related art in which a certain first fuel temperature TDF4 (black triangle) is higher than the temperature T1 (cross mark) evaluated from the saturated vapor pressure curve C1. As a result, it is possible to suppress the vaporization of the LPG fuel.

According to the liquefied gas fuel supplying apparatus in the first embodiment described above, only when it is determined that the first fuel temperature TDF of the LPG fuel estimated as the temperature after the stop of the engine 1 is higher than the temperature T1 evaluated from the predetermined saturated vapor pressure curve C1, the fuel cooler 12 is driven. Therefore, it is unnecessary to drive the fuel cooler 12 all the time. As a result, it is possible to prevent the decrease in the fuel efficiency of the engine 1. Further, the LPG fuel is appropriately cooled during the operation of the engine 1, and therefore, at the restart time of the engine 1 at a high temperature, the temperature of the LPG fuel is kept low, resulting in the suppression of the vaporization of the fuel. Therefore, even at the restart time of the engine 1 at a high temperature, the vaporized LPG fuel is not supplied to the engine 1, and it is possible to enhance the restartability of the engine 1 at a high temperature.

In the first embodiment, since the cooling of the LPG fuel is performed during the operation of the engine 1, it is unnecessary to deal with the vaporization of the LPG fuel at the start time of engine 1. Therefore, unlike the related art, it is unnecessary to secure the time to drive the fuel pump at the start time of the engine, for performing the pump pre-drive control. Further, the driver does not need to wait for the start of the engine 1, and the start responsivity of the engine 1 is not impaired. Further, during the stop of the engine 1, devices such as the fuel pump 4 are not driven or stopped without the operation by the driver. Therefore, the driving sound, which is noise, does not give the driver uncomfortable feeling.

In the first embodiment, when the first fuel temperature TDF after the stop of the engine 1 is estimated, the predetermined value previously evaluated by the experiment is simply added to the detection value by the first fuel temperature sensor 31. Therefore, it is possible to easily estimate the first fuel temperature TDF after the stop of the engine 1. Thereby, it is possible to simplify the preferred control of the fuel cooler 12.

Next, a second embodiment in which the liquefied gas fuel supplying apparatus in the invention is embodied will be described in detail, with reference to the drawings.

Here, in the following description, for constituents equivalent to those in the above first embodiment, identical reference numerals are assigned, and the descriptions are omitted. In the following, differences will be mainly described.

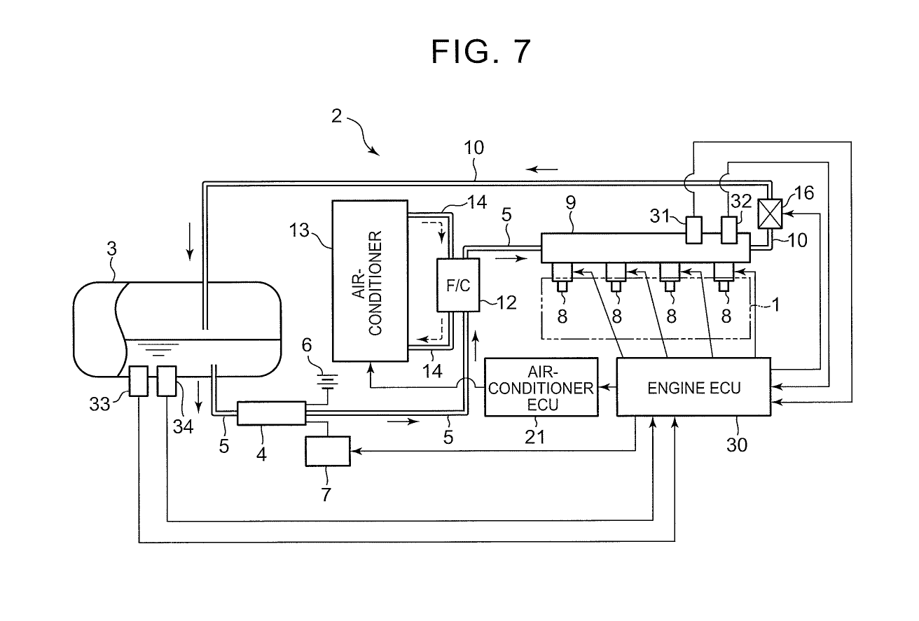

FIG. 7 shows, as a schematic configuration diagram, a liquefied gas fuel supplying apparatus in the second embodiment. The configuration of the second embodiment is different from the configuration of the first embodiment in that an electrically-operated pressure regulator 16 capable of changing the regulation pressure by electronic control is provided on the return passage 10, instead of the pressure-operated pressure regulator 11, and the pressure regulator 16 is controlled by the engine ECU 30. The electrically-operated pressure regulator 16 is an example of the pressure regulator in the invention.

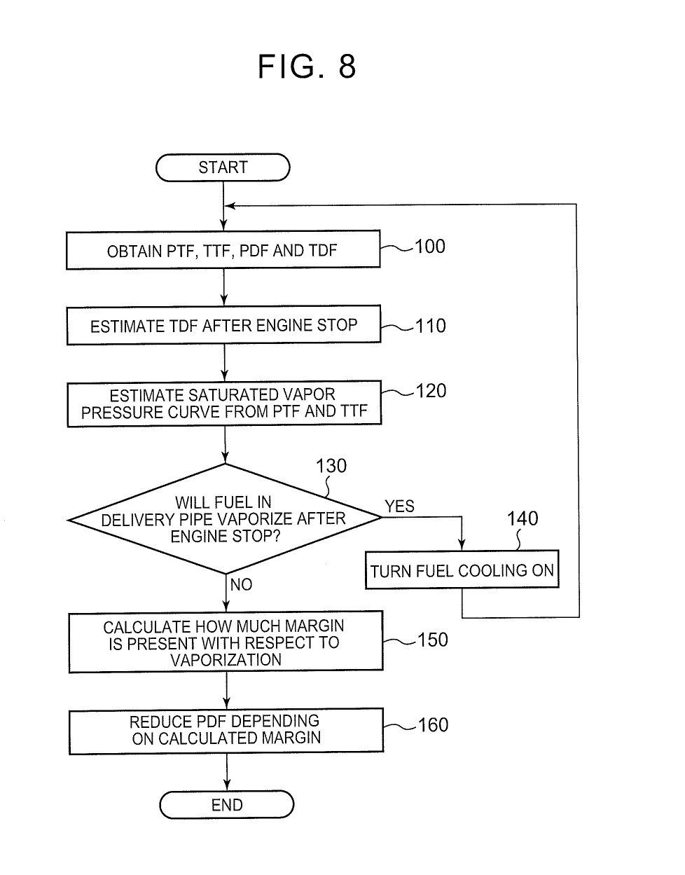

Further, the configuration of the second embodiment is different from that of the first embodiment in the content of the fuel supplying control. The content of a fuel supplying control to be executed by the engine ECU 30 will be described with reference to a flowchart of FIG. 8. The configuration of the flowchart of FIG. 8 is different from that of the flowchart of FIG. 2, in that processes of steps 150, 160 are added.

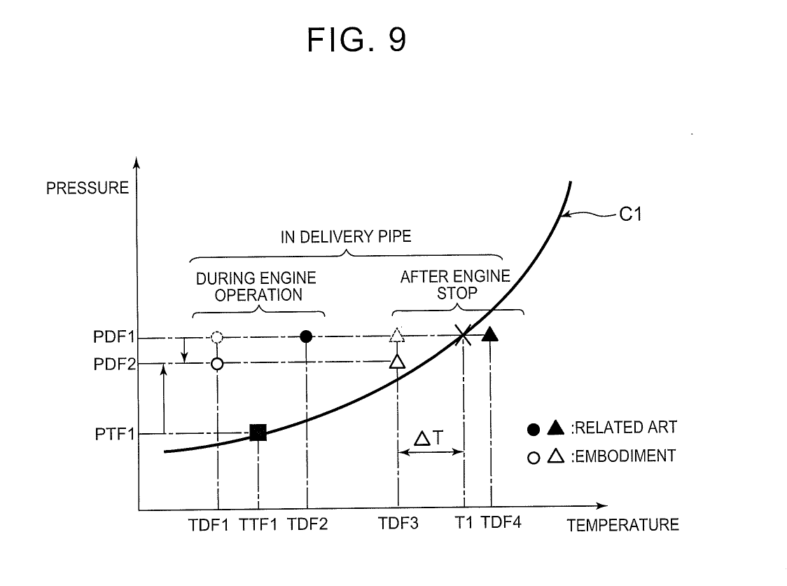

When the process transitions to this routine, the engine ECU 30 executes the processes of step 100 to step 140, similarly to the first embodiment. Thereafter, the process transitions from step 130, and in step 150, in the case where the LPG fuel in the delivery pipe 9 does not vaporizes, how much margin is present with respect to the vaporization is calculated. FIG. 9 shows a graph corresponding to FIG. 6. As shown in FIG. 9, for example, at the certain first fuel pressure PDF1, a temperature difference ΔT of the certain first fuel temperature TDF3 from the temperature T1 (cross mark) evaluated from the saturated vapor pressure curve C1 is evaluated. The engine ECU 30 calculates the temperature difference ΔT.

Then, in step 160, the engine ECU 30 reduces the first fuel pressure PDF, depending on the calculated margin (the temperature difference ΔT). For this, the engine ECU 30 controls the electrically-operated pressure regulator 16, and then terminates the subsequent process. That is, as shown in FIG. 9, the certain first fuel pressure PDF1 is reduced to a certain first fuel pressure PDF2 that is lower than that. As shown in FIG. 9, even when the first fuel pressure PDF is reduced in this way, the certain first fuel temperature TDF3 after the engine stop does not exceed the temperature T1 evaluated from the saturated vapor pressure curve C1. Further, it is possible to reduce the quantity of the pressurization to the LPG fuel by the fuel pump 4, by the quantity of the reduction of the first fuel pressure PDF.

According to the liquefied gas fuel supplying apparatus in the second embodiment described above, the following function effects can be obtained, in addition to the function effects of the first embodiment. That is, in the embodiment, in the case where the estimated first fuel temperature TDF is lower than the temperature T1 evaluated from the saturated vapor pressure curve C1, in order to reduce the pressure (the first fuel pressure PDF) of the LPG fuel to be pumped to the injectors 8 depending on the lowness degree (the temperature difference ΔT), the engine ECU 30 performs the drive control of the electrically-operated pressure regulator 16, and decreases the pumping force to the LPG fuel by the fuel pump 4, by the quantity of the reduction of the pressure. Therefore, the quantity of the pressurization to liquefied gas fuel by the fuel pump 4 is reduced, and therefore, the load on the fuel pump 4 is reduced. As a result, it is possible to extend the durability life of the fuel pump 4, and it is possible to reduce the electric power consumption by the fuel pump 4, and further enhance the fuel efficiency of the engine 1, corresponding to the quantity.

Next, a third embodiment in which the liquefied gas fuel supplying apparatus in the invention is embodied will be described in detail, with reference to the drawings.

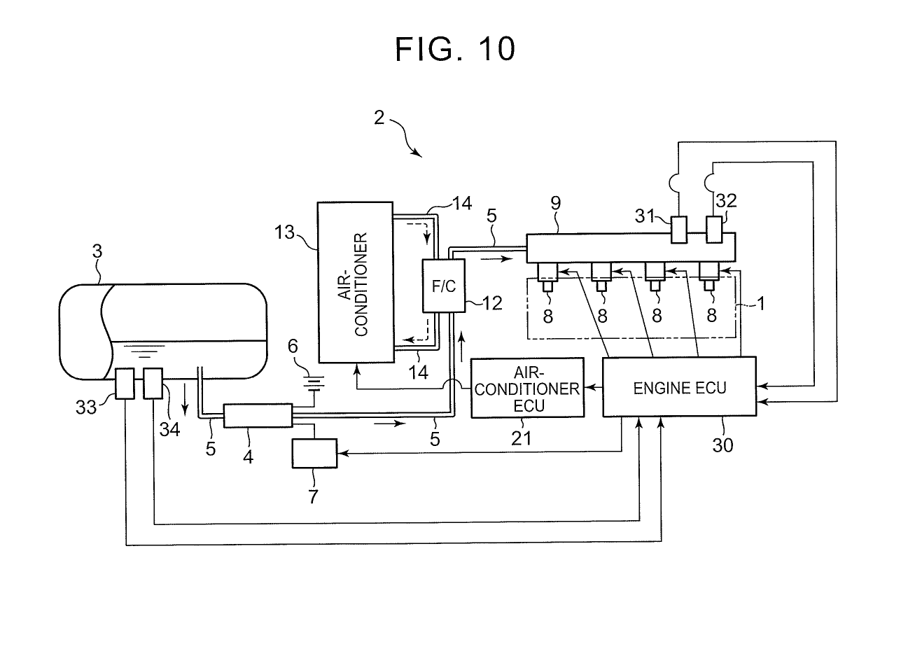

FIG. 10 shows, as a schematic configuration diagram, a liquefied gas fuel supplying apparatus in the third embodiment. The configuration of the third embodiment is different from that of the second embodiment in that the return passage 10 and the electrically-operated pressure regulator 16 are excluded from the liquefied gas fuel supplying apparatus. That is, the embodiment adopts a returnless type liquefied gas fuel supplying apparatus in which the excess LPG fuel in the delivery pipe 9 is not returned to the fuel tank 3. Therefore, the engine ECU 30 performs the regulation control of the output of the fuel pump 4, for supplying a necessary and sufficient amount of LPG fuel to the injectors 8 depending on the operation state of the engine 1. Further, in the embodiment, unlike step 160 in the flowchart of FIG. 8, the engine ECU 30 does not control the electrically-operated pressure regulator 16, in the reduction of the certain first fuel pressure PDF1 to the certain first fuel pressure PDF2. Instead, the engine ECU 30 controls the output of the fuel pump 4 such that the certain first fuel pressure PDF1 is reduced to the certain first fuel pressure PDF2. In this respect, the embodiment is different in configuration from the second embodiment.

Therefore, in the third embodiment, it is possible to obtain the function effects equivalent to the second embodiment. In addition, since the liquefied gas fuel supplying apparatus is configured as a returnless type, it is possible to simplify the pipe configuration of the apparatus.

Here, the invention is not limited to the above embodiments, and for the implementation, a part of the configuration can be appropriately modified in range without departing from the spirit of the invention.

The above embodiments adopt a configuration in which the temperature of the LPG fuel in the delivery pipe 9 after the stop of the engine 1 is estimated, during the operation of the engine 1, based on the detection value by the first temperature sensor 31, and when the estimated temperature is higher than a temperature evaluated from a predetermined saturated vapor pressure curve, the fuel cooler 12 is driven and controlled for cooling the LPG fuel. However, it is allowable to adopt a configuration in which, during the operation of the engine 1, whether the LPG fuel in the delivery pipe 9 will vaporize after the stop of the engine 1 is determined from the detection value by the first temperature sensor 31, by reference to a predetermined map or the like, and when it is determined that the LPG fuel will vaporize, the fuel cooler 12 is driven and controlled for cooling the LPG fuel.

In the above embodiments, the liquefied gas fuel supplying apparatus is embodied in an ordinary engine vehicle using the liquefied gas fuel, but can be embodied also in a hybrid vehicle using the liquefied gas fuel. In this case, during the intermittent stop of the engine, the condition in the delivery pipe does not shift to a vaporization region, and during the engine stop, it is unnecessary to drive and stop the fuel pump without the operation by the driver. Therefore, the driving sound, which is noise, does not give the driver uncomfortable feeling.

In the above embodiments, the LPG fuel is used as the liquefied gas fuel, but dimethyl ether (DME) or other fuels also can be used as the liquefied gas fuel.

The invention can be utilized in ordinary engine vehicles using the liquefied gas fuel, and hybrid vehicles each of which concurrently uses an engine using the liquefied gas fuel and a motor.

What is claimed is:

1. A liquefied gas fuel supplying apparatus comprising:
an injector configured to perform injection supply of liquefied gas fuel to an engine;
a fuel tank configured to store the liquefied gas fuel;
a fuel pump configured to pump the liquefied gas fuel stored in the fuel tank, to the injector through a pipe;
a fuel cooler configured to cool the liquefied gas fuel that is pumped from the fuel pump to the injector through the pipe;
a fuel temperature detector configured to detect a temperature of the liquefied gas fuel in the pipe positioned on a downstream side relative to the fuel cooler; and
an electronic control unit configured to:
(i) determine whether the liquefied gas fuel in the pipe positioned on the downstream side relative to the fuel cooler vaporizes after the engine is stopped, based on a detection value detected by the fuel temperature detector, the detection value being a detection value while the engine is operated; and
(ii) perform drive control of the fuel cooler to cool the liquefied gas fuel, when the electronic control unit determines that the liquefied gas fuel vaporizes.

2. A liquefied gas fuel supplying apparatus comprising:
an injector configured to perform injection supply of liquefied gas fuel to an engine;
a fuel tank configured to store the liquefied gas fuel;
a fuel pump configured to pump the liquefied gas fuel stored in the fuel tank (3), to the injector through a pipe;
a fuel cooler configured to cool the liquefied gas fuel that is pumped from the fuel pump to the injector through the pipe;
a fuel temperature detector configured to detect a temperature of the liquefied gas fuel in the pipe positioned on a downstream side relative to the fuel cooler; and
an electronic control unit configured to:
(i) estimate the temperature of the liquefied gas fuel in the pipe positioned on the downstream side relative to the fuel cooler, based on a detection value detected by the fuel temperature detector, while the engine is operated, the temperature being a temperature after the engine is stopped; and
(ii) perform drive control of the fuel cooler to cool the liquefied gas fuel, when the estimated temperature is higher than a temperature that is evaluated from a predetermined saturated vapor pressure curve.

3. The liquefied gas fuel supplying apparatus according to claim 2, wherein
the electronic control unit is configured to estimate the temperature of the liquefied gas fuel in the pipe positioned on the downstream side relative to the fuel cooler, by adding a predetermined value to the detection value detected by the fuel temperature detector, the temperature being the temperature after the engine is stopped, the predetermined value being previously evaluated by an experiment.

4. The liquefied gas fuel supplying apparatus according to claim 2, further comprising a pressure regulator configured to regulate a pressure of the liquefied gas fuel that is pumped to the injector,
wherein the electronic control unit is configured to:
(i) perform drive control of the pressure regulator so as to reduce the pressure of the liquefied gas fuel that is pumped to the injector, depending on a temperature difference between the estimated temperature and the temperature that is evaluated from the saturated vapor pressure curve, when the estimated temperature is lower than the temperature that is evaluated from the saturated vapor pressure curve; and
(ii) decrease pumping force to the liquefied gas fuel by the fuel pump, by a reduction quantity of the pressure of the liquefied gas fuel.
